(19) United States
(12) Patent Application Publication
(10) Pub. No.: US 2014/0004359 A1
(43) Pub. Date: Jan. 2, 2014

(54) HYDROSILYLATION REACTION INHIBITORS AND USE THEREOF FOR PREPARING STABLE CURABLE SILICONE COMPOSITIONS

(71) Applicants: Sebastien Marrot, Lyon (FR); Yassine Maadadi, Meyzieu (FR)

(72) Inventors: Sebastien Marrot, Lyon (FR); Yassine Maadadi, Meyzieu (FR)

(73) Assignee: Bluestar Silicones France, Lyon (FR)

(21) Appl. No.: 13/997,612

(22) PCT Filed: Dec. 20, 2011
(86) PCT No.: PCT/FR2011/000665

§ 371 Date: Sep. 18, 2013

(30) Foreign Application Priority Data
Dec. 24, 2010 (FR) 1005111

(51) Int. Cl. C09D 7/12

(52) U.S. Cl. CPC C09D 7/1233
USPC 428/447; 524/765; 524/706; 427/387

(57) ABSTRACT

An inhibitor compound suitable for inhibiting the curing of a silicone composition is described. Further, the silicone composition is a silicone-elastomer precursor, obtained by means of a hydrosilylation reaction.

The present invention relates to the use of inhibiting compounds, in particular of inhibiting compounds appropriate for inhibiting the curing of a silicone composition which is the precursor of a silicone elastomer obtained by hydrosilylation reaction.

Hydrosilylation reactions are widespread in the silicone industry for not only accessing functionalized silanes or siloxanes but also for the preparation of silicone networks obtained by crosslinking between polymethylhydrosiloxane and polymethylvinylsiloxane oils. These reactions are generally carried out by virtue of organometallic catalysis with platinum and in particular Karstedt platinum, valued for its high reactivity and its solubility in a silicone medium. Under these conditions, hydrosilylation reactions have rapid kinetics at ambient temperature and a few tens of ppm (parts by million) of catalysts are sufficient to complete a reaction in a few minutes. Silicone compositions which can be crosslinked by hydrosilylation reactions are thus used to form water-repellant and nonstick coatings or films on supports made of paper or of polymer film. However, for these applications, it is necessary to temporarily inhibit the hydrosilylation reaction in order to have the time to prepare, transport and make use of the formulation bath. The temporary inhibition of the polyaddition systems is made possible by the use of organic compounds which act as inhibitors which can be thermally activated by the effect of temperature or by the use of photonic catalytic systems which can be activated by UV radiation. For example, for the paper release application, it is required that the formulation bath remain liquid for several hours at ambient temperature and that the crosslinking be extremely rapid (a few seconds) when the bath is deposited on a support and introduced into coating ovens, the temperature of which is maintained at between 100 and 150° C.

When it is necessary to increase the pot life of the organopolysiloxane compositions which can be crosslinked and/or cured by polyaddition reaction, it is standard to incorporate a curing inhibitor. Curing inhibitors are compounds which slow down the curing at ambient temperatures but which do not delay the curing at higher temperatures. These curing inhibitors are sufficiently volatile to be driven off from the coating compositions.

It is known (see, for example, patent U.S. No. Pat. 3,445,420) to use α-acetylenic compounds, such as acetylenic alcohols with a boiling point of less than 250° C., in particular 2-methyl-3-butyn-2-ol and ethynylcyclohexanol (ECH), as hydrosilylation inhibitors in curable silicone compositions based on an organosilicic polymer carrying substituents having olefinic unsaturation (in particular vinylic unsaturation), on an organohydrosiloxane polymer and on a catalyst of the platinum or platinum compound type.

The presence of these acetylenic compounds inhibits the platinum catalyst by preventing it from catalyzing the curing reaction at ambient temperature but not at high temperature. Specifically, the curable silicone compositions which comprise this type of inhibitor can be cured by increasing the temperature of the composition to a temperature greater than the boiling point or sublimation point of the inhibitor, thus evaporating the inhibitor or a portion of the inhibitor, and allowing the catalyst to catalyze the hydrosilylation reaction and consequently to cure the silicone composition.

However, although widely used, ethynylcyclohexanol (ECH) exhibits the disadvantage of not being able to be packaged in the presence of a very widespread platinum catalyst, which is Karstedt platinum, during the storage of these compositions before they are used. Specifically, if these two compounds are in the presence of one another at ambient temperature (20° C.), a precipitation of the platinum in the form of colloids is then observed, which colloids strongly color the formulation (appearance of a yellow coloration which changes to a black coloration after only a few hours). This is a major problem for the storage of such compositions. It is for this reason that polyaddition silicone compositions employing true α-acetylenic alcohols, such as ECH are packaged, before they are used, in the “multicomponent” form, that is to say that the constituents of the composition are placed in separated parts (or components) so as to separate:
the inhibitor from the catalyst, in order to prevent the coloration problems, and
the organohydrosiloxane polymer from the catalyst, for safety reasons.

Thus, a conventional polyaddition silicone composition for an application in paper release is packaged, before its use, in a multicomponent form commonly comprising 3 or 4 separate parts:
a 1st part (I) comprising at least polymethylvinylsiloxanes and the inhibitor of the hydrosilylation reaction, which ensures the stability and the use of the formulations,
a 2nd part (II) comprising at least one hydrosiloxane polymer,
a 3rd part (III) comprising a platinum-based catalyst, and
optionally a 4th part (IV) comprising the formulation additives which introduce properties intrinsic to the desired applications.

It is known that, during the use of these compositions packaged in the multicomponent form, the part (I) and the catalyzing part (III) must not be directly mixed. It is for this reason that standard practice consists in mixing beforehand the parts (I) and (II) comprising the polymethylvinylsiloxanes and the hydrosiloxane polymers, before introducing the catalyzing part (III), thus preventing the phenomenon of precipitation of the catalyst and of the coloring of the composition.

Among the inhibitors of the hydrosilylation reaction, acetylenic α,α′-diols do not exhibit these problems. They can be brought into the presence of the platinum catalyst without resulting in the precipitation phenomenon described above. This has the advantage of reducing the number of components for the polyaddition system. However, these inhibitors are not very soluble in a silicone medium, resulting in opaque formulations. This explains their restricted use, in particular for the paper release application, where the transparency is an essential criterion. Furthermore, the compositions comprising acetylenic α,α′-diols, such as, for example, the compound 2,4,7,9-tetramethyl-5-decyne-4,7-diol (TMDD), generally have a faster crosslinking time at ambient temperature than those comprising a true α-acetylenic alcohol (for example ECH). This also explains their restricted use, in particular for the paper release application, where the crosslinking time at ambient temperature has to be sizeable so as to be able to prepare the production of the coated supports in an effective manner without adding an additional constraint related to the stability of the coating baths (problem of gelling comprising the silicone compositions).

It therefore has to be found that the prior technical proposals do not introduce satisfactory solutions, in particular for exacting applications, such as the coating on supports of silicone compositions for preparing water-repellant coatings.

One of the essential objectives of the present invention is to provide a silicone composition X capable of curing by a polyaddition reaction which:
no longer exhibits a problem of precipitation of the platinum catalyst when the latter is packaged in the presence of an inhibitor during the storage of the composition,
is stable for several hours at ambient temperature, when all the constituents of the composition are mixed before the use of the composition, in particular during machine coating operations; and
rapidly crosslinks on a support at a conventional curing temperature of between 100 and 180° C.

Another essential objective of the present invention is to provide a process for coating on a flexible support employing a composition according to the invention.

Thus, the main subject matter of the invention is a composition X which can be crosslinked and/or cured by polyaddition reactions and which is provided in the form of a multicomponent system S comprising at least two separate parts A and B intended to be mixed in order to form a composition X′ in which:

a) the part A comprises:
at least one polyorganosiloxane V comprising, per molecule, at least two alkenyl radicals bonded to silicon atoms,
at least one catalyst E composed of at least one metal belonging to the platinum group and preferably a Karstedt platinum,
at least one inhibitor D1 which is an acetylenic α,α′-diol, and
at least one organic acid or one inorganic acid D2, with the condition that the inorganic acid does not comprise platinum, such as chloroplatinic acid, and

b) the part B comprises:
at least one polyorganosiloxane H exhibiting, per molecule, at least two hydrogen atoms bonded to an identical or different silicon atom.

The term “inorganic acid” is understood to mean that this expression does not comprise the acid derivatives of platinum, such as chloroplatinic acid, which are known as catalysts.

The Applicant Company has found, entirely unexpectedly, that which forms precisely the subject matter of the present invention, that the use, as hydrosilylation inhibitor, of an acetylenic α,α′-diol in combination with an organic or inorganic acid in the same part of a composition packaged in multicomponent form for the storage thereof, makes it possible:
to improve the solubility of the acetylenic α,α′-diol inhibitor in a silicone medium, resulting in a completely transparent and colorless mixture,
to maintain a restricted number of components of the system, in comparison with the case where the inhibitor is of the true α-acetylenic alcohol type, and
to improve the inhibition time at ambient temperature in comparison with an identical acid-free system, while having inhibition raising temperature performances comparable to the true α-acetylenic alcohols, such as ECH.

According to a preferred embodiment, the composition X according to the invention is such that:

a) the part A comprises:
at least one polyorganosiloxane V comprising, per molecule, at least two alkenyl radicals bonded to silicon atoms,
at least one catalyst E composed of at least one metal belonging to the platinum group and preferably a Karstedt platinum,
at least one inhibitor D1 which is an acetylenic α,α′-diol, and
at least one organic acid or one inorganic acid D2, chosen from the group consisting of orthophosphoric acid, orthophosphorous acid, periodic acid, sulfuric acid, sulfurous acid and thiosulfuric acid, and

b) the part B comprises:
at least one polyorganosiloxane H exhibiting, per molecule, at least two hydrogen atoms bonded to an identical or different silicon atom.

According to a preferred embodiment, the composition comprises a third part C which comprises at least one additive F and which is separate from the parts A and B.

Preferably, the inhibitor D1 is an acetylenic α,α′-diol of following formula (1):

(R¹)(R²)(OH)C—C≡C—C(OH)(R³)(R⁴) (1)
in which the R¹, R², R³ and R⁴ radials, which are identical or different, represent independently of one another, a monovalent linear or branched alkyl group, a cycloalkyl group, a (cycloalkyl)alkyl group, an aromatic group or an arylalkyl group, and
the R¹, R², R³ and R⁴ radicals can be bonded in pairs so as to form a 5-, 6-, 7- or 8-membered aliphatic ring optionally substituted by one or more substituents.

Preferably, the inhibitor D1 is chosen from the group consisting of the acetylenic α,α′-diols of following formulae (2) to (9):

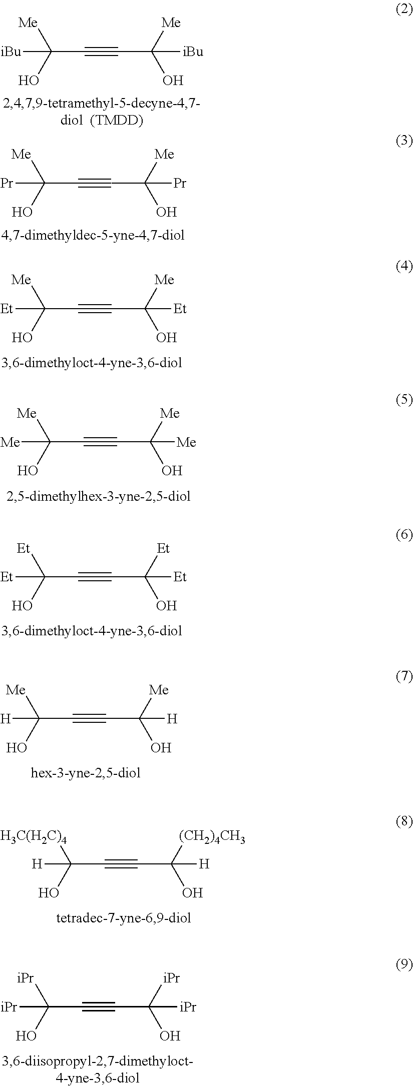

Preferably, the [inhibitor D1]/[acid D2] molar ratio is between 0.1 and 20 and preferably between 1 and 10 and more preferably still between 2.5 and 6.5.

According to a preferred embodiment, the acid D2 exhibits, in aqueous solution and at 25° C., at least one pKa having a value within the following range: −0.9≦pKa≦+6.5.

Examples of acid D2 which are of use according to the invention are, for example, chosen from the group consisting of the following acids:
methanoic acid, ethanoic acid, propanoic acid, butanoic acid, pentanoic acid, hexanoic acid, heptanoic acid, octanoic acid, nonanoic acid, decanoic acid, dodecanoic acid, hexadecanoic acid, octadecanoic acid, benzoic acid, ethanedioic acid, 1,3-propanedioic acid, 1,4-butanedioic acid, 1,5-pentanedioic acid, 1,6-hexanedioic acid, benzenecarboxylic acid, cyclopentanecarboxylic acid, para-aminobenzoic acid, adipic acid, ortho-aminobenzoic acid, citric acid, lactic acid, maleic acid, malic acid, malonic acid, mandelic acid, pyruvic acid, salicylic acid, succinic acid, oxalic acid, glutaric acid, phthalic acid, benzene-1,4-dicarboxylic acid, picric acid, pimelic acid, fumaric acid, glycolic acid, sebacic acid, chloroethanoic acid, dichloroethanoic acid, trifluoroacetic acid, ascorbic acid, dichloroethanoic acid, trichloroacetic acid, tartaric acid, boric acid, chlorosulfuric acid, fluoroboric acid, fluorosulfuric acid, nitric acid, perchloric acid, phosphoric acid, sulfuric acid, orthophosphoric acid, orthophosphorous acid, periodic acid, sulfuric acid, thiocyanic acid and thiosulfuric acid.

According to another preferred embodiment, the acid D2 is chosen from the group consisting of methanoic acid, orthophosphoric acid, heptanoic acid, trifluoroacetic acid and malonic acid.

It is advantageous for the [inhibitor D1]/[catalyst C] molar ratio to be between 10 and 60 and for the [acid D2]/[catalyst C] molar ratio to be between 10 and 60.

According to an alternative form of the invention, the proportions of the polyorganosiloxane V and of the organohydropolysiloxane H are such that the molar ratio of the hydrogen atoms bonded to the silicon in the organohydropolysiloxane H to the alkenyl radicals bonded to the silicon in the organopolysiloxane V is between 0.4 and 10.

Advantageously, the polyorganosiloxane V according to the invention exhibits:
at least two siloxyl units of formula (V.1):

TₐZ_{b}SiO_{4-(a+b)/2} (V.1)

in which:
T is an alkenyl group,
Z is a monovalent hydrocarbon group chosen from the group consisting of alkyl groups having from 1 to 8 carbon atoms inclusive, optionally substituted by at least one halogen atom, and aryl groups, and
a is equal to 1 or 2, b is equal to 0, 1 or 2 and the sum a+b is between 1 and 3, and
optionally at least a portion of the other siloxyl units are units of formula (V.2).

Z_{c}SiO_{4-c/2} (V.2)
in which:
   Z has the same meaning as above and c is equal to 0, 1, 2 or 3.

In general, the organopolysiloxane V has a viscosity at least equal to 50 mPa·s and preferably less than 200 000 mPa·s.

Advantageously, the organohydropolysiloxane H according to the invention exhibits:
at least two, and preferably at lease three siloxyl units of formula (H.1):

H_{d}LₑSiO_{4-(d+e)/2} (H.1)
in which:
   L is a monovalent hydrocarbon group which does not have an unfavorable action on the activity of the catalyst and which is chosen from the group consisting of alkyls having from 1 to 8 carbon atoms inclusive, optionally substituted by at least one halogen atom, and aryls,
   H is a hydrogen atom, and
   d is equal to 1 or 2, e is equal to 0, 1 or 2 and the sum d+e is equal to 1, 2 or 3, and
optionally at least a portion of the other siloxyl units are units of formula (H.2):

L_{g}SiO_{4-g/2} (H.2)

in which:
L has the same meaning as above and g is equal to 0, 1, 2 or 3.

In general, the dynamic viscosity of the organohydropolysiloxane H is at least equal to 10 mPa·s and it is preferably between 20 and 1000 mPa·s.

Advantageously, the proportions of the polyorganosiloxane V and of the polyorganosiloxane H are such that the molar ratio of the hydrogen atoms bonded to the silicon in the polyorganosiloxane H to the alkenyl radicals bonded to the silicon in the polyorganosiloxane V is between 0.4 and 10. In particular, the proportions of the siloxyl units (V.1) and (H.1) are such that the molar ratio of the hydrogen atoms bonded to the silicon in the organohydropolysiloxane H to the alkenyl radicals bonded to the silicon in the organopolysiloxane V is between 0.4 and 10.

According to an alternative form of the invention, the silicone composition X according to the invention can comprise one or more additives which are conventional in the field of silicone unstick coatings for a solid support, for example made of paper. The additive can, for example be an antimisting additive, such as silica particles, or branched polyorganosiloxanes, and the like.

According to another alternative form, the silicone composition X according to the invention can also comprise an adhesion-modulating system and also additives normal in this type of application, such as bactericides, antifreezes, wetting agents, antifoaming agents, fillers, synthetic latexes or colorants.

Another subject matter of the invention is a silicone composition X′ obtained by mixing the parts of the composition X as described above.

The silicone composition X′ according to the invention can be applied with the help of devices used on industrial machines for the coating of paper, such as a 5-roll coating head, air knife systems or equalizing bar systems, to flexible supports or materials and then cured by moving through tunnel ovens heated to 70-200° C.; the passage time in these ovens depends on the temperature; it is generally of the order of 5 to 15 seconds at a temperature of the order of 100° C. and of the order of 1.5 to 3 seconds at a temperature of the order of 180° C.

The silicone composition X′ can be deposited on any flexible material or substrate, such as paper of various types (supercalendered, coated, glassine), board, cellulose sheets, metal sheets, plastic films (polyester, polyethylene, polypropylene, and the like), and the like.

The amounts of composition deposited are generally of the order of 0.1 to 5 g per m² of surface area to be treated, which corresponds to the deposition of layers of the order of 0.1 to 5 μm.

The materials or supports thus coated can subsequently be brought into contact with any pressure-sensitive rubber, acrylic or other adhesive material. The adhesive material is then easily detachable from said support or material.

All the viscosities concerned with in the present report correspond to a dynamic viscosity quantity which is measured, in a way known per se, at 25° C.

In the continuation of the present patent application, the polyorganosiloxane oils will be described in a conventional way using the normal notation, in which the letters M, D, T and Q are used to denote various siloxyl units. In this notation, the silicon atom of a siloxyl unit is involved in one (M), two (D), three (T) or four (Q) covalent bonds with as many oxygen atoms. When an oxygen atom is shared between two silicon atoms, it is counted as ½ and it will not be mentioned in an abbreviated formula. On the other hand, if the oxygen atom belongs an alkoxyl or hydroxyl group bonded to a silicon atom, this chemical functional group will be indicated in brackets in the abbreviated formula. By default, the remaining bonds of the silicon atom are regarded as connected to a carbon atom. Generally, the hydrocarbon groups bonded to the silicon via a C-Si bond are not mentioned and generally correspond to an alkyl group, for example a methyl group. When a hydrocarbon group has a specific functional group, it is indicated in superscript.

For example, the abbreviated formulae:
M^{Vi} represents a unit in which the silicon atom is bonded to an oxygen atom and one of the hydrocarbon groups of which forming a C-Si bond is a vinyl group, that is to say a dialkylvinylsiloxyl unit, and
M′ represents a unit in which the silicon atom is bonded to a hydrogen atom, to an atom and to two methyl groups.

Mention may be made, as reference work, of Noll, “Chemistry and technology of silicones”, chapter 1.1, pages 1-9, Academic Press, 1968-2nd edition.

According to another of its aspects, the present invention relates to a silicone elastomer Y obtained by crosslinking or curing the silicone composition X′ according to the invention and described above.

The present invention also relates to the use of the silicone composition X′ according to the invention as coating base for the production of non-stick and water-repellent crosslinked elastomer coatings on a solid support, preferably a flexible solid support, such as a paper, a board, a cellulose sheet, a metal sheet or a plastic film.

Another subject matter of the invention is a solid support at least partially coated using the silicone composition X′ according to the invention and as described above, and crosslinked or cured by heating at a temperature of greater than 60° C. and preferably of between 70° C. and 200° C., or the silicone elastomer Y according to the invention and as described above.

The present invention also relates to a process for coating on a flexible support S comprising the following stages a), b), c) and d):
a) a silicone composition X according to the invention and as described above is prepared,
b) the parts of the silicone composition X are mixed in order to form a composition X′,
c) said silicone composition X′ is then deposited, continuously or noncontinuously, on said flexible support S, and
d) the silicone composition X′ is crosslinked by heating at a temperature of greater than 60° C. and preferably of between 70° C. and 200° C.

Preferably, the flexible support S is made of paper, of textile, of board, of metal or of plastic.

For example, the flexible support S can be made of textile, of paper, of polyvinyl chloride (PVC), of polyester, of polypropylene, of polyamide, of polyethylene, of polyurethane, of nonwoven glass fiber fabrics or of polyethylene terephthalate (PET).

Finally, the last subject matter of the invention is a silicone composition comprising:
at least one polyorganosiloxane V comprising, per molecule, at least two alkenyl radicals bonded to silicon atoms,
at least one catalyst C composed of at least one metal belonging to the platinum group,
at least one inhibitor D1 which is an acetylenic α,α′-diol, and
at least one organic acid or one inorganic acid D2, with the condition that the inorganic acid does not comprise platinum, such as chloroplatinic acid.

This composition is of use as part A of the composition X according to the invention.

The nonlimiting examples which follow will make possible a better understanding of the invention and will make it possible to grasp therefrom all its advantages and alternative embodiments.

### EXAMPLES

Products Used
Polydimethylsiloxane oil vinylated at the chain end (V.1): of mean formula M^{Vi}D₇₅M^{Vi} and of viscosity at 25° C.=100 mPa·s.
Polydimethylsiloxane oil vinylated at the chain end (V.2): of viscosity at 25° C.=350 mPa·s.
Polymethylhydrosiloxane oil (H.1): (0.73 mol SiH per 100 g of oil, i.e. 6.84 mmol of SiH).
Catalyst (C), Karstedt platinum, in the form of a mixture: Pt catalyst (2800 ppm)+polydimethylsiloxane oil vinylated at the chain end (V.2).
Inhibitor (D1.I1) (invention): 2,4,7,9-tetramethyl-5-decyne-4,7-diol (TMDD).
Inhibitor (D1.C1) (comparative): 1-ethynyl-1-cyclohexanol (ECH).
Trifluoroacetic acid (D2.I1): CF₃COOH; (pK1=0.23).
Heptanoic acid (D2.I2): CH₃(CH₂)₅COOH; (pK1=4.89).
Orthophosphoric acid (D2.I3): H₃PO₄; (pK1=2.15).

### Example 1

Parts A of silicone compositions crosslinkable and/or curable by polyaddition reactions and packaged in the two-component form are prepared from the components listed in the following table 1:

TABLE 1

| | Part A1 | | Part A2 | | Part A3 | | Part A4 | |
|---|---|---|---|---|---|---|---|---|
| | Invention | | Comparative | | Comparative | | Comparative | |
| Mixture: Vinylated polydimethylsiloxane oil | 0 | | 0 | | 10 | g | 10 | g |
| (V1) + 0.15% by weight of inhibitor ECH | | | | | 3.8 | mmol | 3.8 | mmol |
| (D1.C1) | | | | | | | | |
| Vinylated polydimethylsiloxane oil (V1) | 10 | g | 10 | g | 0 | | 0 | |
| | 3.8 | mmol | 3.8 | mmol | | | | |
| Catalyst (C) [mmol] | 100 | mg | 100 | mg | 100 | mg | 100 | mg |
| | 0.0014 | mmol | 0.0014 | mmol | 0.0014 | mmol | 0.0014 | mmol |
| Inhibitor (D1.I1) [mmol] | 109 | mg | 109 | mg | 0 | | 0 | |
| | 0.484 | mmol | 0.484 | mmol | | | | |
| Acid (D2.I2) [mmol] | 10 | mg | 0 | | 0 | | 10 | mg |

| | |
|---|---|
| (density 0.91) | (density 0.91) |

| | | | |
|---|---|---|---|
| 0.076 | mmol | 0.076 | mmol |

The inhibitor (D1.I1) is dissolved beforehand in the vinylated polydimethylsiloxane oil (V1) at 50° C. for 30 min before addition to the parts A concerned (parts A1 and A2). Initially, the four mixtures (parts A1 to A4) are clear and colorless. They are then stirred at ambient temperature for 24 hours and exhibit the following appearances:
The formulation Al (Invention) is completely clear.
The two formulations, Parts A3 and A4 (Comparative), comprising ECH and Pt catalyst, have assumed a yellow/brown coloration, indicating the precipitation of a portion of the platinum in the form of colloids. The addition of acid does not make it possible to prevent the phenomenon of precipitation (Part A4).
The formulation Part A2 (Comparative) exhibits a milky and opaque appearance having a white color.

### Example 2

A part B comprising 0.93 g of a polymethylhydrosiloxane oil (H.1) was added to each of the parts described in example 1. A sample for each composition is withdrawn and analyzed by DSC (Differential Scanning Calorimetry, device of Metler type). The analysis is carried out in an open aluminum pan using a temperature gradient from 25° C. to 200° C. at a rate of 10° C./min. The time necessary for the crosslinking at ambient temperature and the bath life are also measured. The thermal profiles, the data characteristic of the exothermic peaks (T° C. peak and ΔT° onset/endset ° C.), are represented in the following table 2.

TABLE 2
Results by DSC analysis

| | T° C. | ΔT° | ΔH |
|---|---|---|---|
| | peak | onset/endset ° C. | (J/g) |
| Composition (I-1) (parts A1 + B) | 115 | 25 | 39 |
| Composition (C-1) (parts A2 + B) | 98 | 33 | 36 |
| Composition (C-2) (parts A3 + B) | 116 | 5 | 47 |
| Composition (C-3) (parts A3 + B) | 107 | 7 | 46 |

### Example 3

### Demonstration of the Improvement in the Inhibition Time at Ambient Temperature for the “acetylenic α,α′-diol+Acid” Inhibition Systems According to the Invention

Parts A of silicone compositions crosslinkable and/or curable by polyaddition reactions and packaged in the two-component form are prepared and mixed with parts B. the resulting compositions are described in the following table 3:

TABLE 3

| Compositions | Constituents | Amount | | Moles | |
|---|---|---|---|---|---|
| Composition I-2 | Vinylated oil (V.1) | 10 | g | 3.8 | mmol |
| | SiH oil (H.1) | 0.93 | g | 6.84 | mmol |
| | Inhibitor (D1.I1) | 109 | mg | 0.484 | mmol |
| | Catalyst (C) | 100 | mg | 0.0014 | mmol |
| | Acid (D2.I1) | 5.1 | mg | 0.045 | mmol |
| Composition I-3 | Vinylated oil (V.1) | 10 | g | 3.8 | mmol |
| | SiH oil (H.1) | 0.93 | g | 6.84 | mmol |
| | Inhibitor (D1.I1) | 109 | mg | 0.484 | mmol |
| | Catalyst (C) | 100 | mg | 0.0014 | mmol |
| | Acid (D2.I3) | 4.4 | mg | 0.045 | mmol |
| composition I-4 | Vinylated oil (V.1) | 10 | g | 3.8 | mmol |
| | SiH oil (H.1) | 0.93 | g | 6.84 | mmol |
| | Inhibitor (D1.I1) | 109 | mg | 0.484 | mmol |
| | Catalyst (C) | 100 | mg | 0.0014 | mmol |
| | Acid (D2.I2) | 5.85 | mg | 0.045 | mmol |
| Composition C-4 | Vinylated oil (V.1) | 10 | g | 3.8 | mmol |
| | SiH oil (H.1) | 0.93 | g | 6.84 | mmol |
| | Inhibitor (D1.I1) | 109 | mg | 0.484 | mmol |
| | Catalyst (C) | 100 | mg | 0.0014 | mmol |

A sample for each composition is withdrawn and analyzed by DSC (Differential Scanning Calorimetry, device of Metier type) according to the same conditions as in example 2. The results are described in the following table 4:

TABLE 4
Results by DSC analysis

| | T° C. | ΔT° | ΔH |
|---|---|---|---|
| | peak | onset/endset ° C. | (J/g) |
| Composition (I-2) | 111 | 26 | 46 |
| Composition (I-3) | 102 | 27 | 43 |
| Composition (I-4) | 108 | 29 | 52 |
| Composition (C-4) | 99 | 36 | 41 |

In the presence of acid and in comparison with the reference, composition (C-4), a higher T° C. peak is observed for the compositions according to the invention (I-2), (I-3) and (I-4), clearly indicating a delaying effect of the acids. Furthermore, in the presence of acid and in comparison with the reference, composition (C-4), a lower ΔT onset/endset is observed for the compositions according to the invention, indicating a decrease in the lagging effects at the start and at the end of the reaction.

For all the compositions, the crosslinking time at ambient temperature but with a reduced amount of inhibitor TMDD (D1.I1) (0.240 mmol) was also monitored. The crosslinking times at ambient temperature are described in the following table 5:

TABLE 5

| | Crosslinking time at ambient T° |
|---|---|
| Compositions | (20° C.) |
| Composition (I-2) | 2 h 15 |
| Composition (I-3) | 9 h 00 |
| Composition (I-4) | 3 h 00 |
| Composition (C-4) | 1 h 30 |

These results clearly show the delaying effect of the organic and inorganic acids with respect to the crosslinking time at ambient temperature.

1. A composition X comprising at least two separate parts A and B intended to be mixed in order to form a composition X′ in which:
a) the part A comprises:
at least one polyorganosiloxane V comprising, per molecule, at least two alkenyl radicals bonded to silicon atoms,
at least one catalyst E composed of at least one metal belonging to the platinum group,
at least one inhibitor D1 which is an acetylenic α,α′-diol, and
at least one organic acid or one inorganic acid D2, with the condition that the inorganic acid does not comprise platinum, and
b) the part B comprises:
at least one polyorganosiloxane H exhibiting, per molecule, at least two hydrogen atoms bonded to an identical or different silicon atom, and wherein the composition X is provided in the form of a multicomponent system S comprising the at least two separate parts A and B and wherein the composition X can be crosslinkable and/or cured by a polyaddition reaction.

2. The composition X as claimed in claim 1, in which:
a) the part A comprises:
at least one polyorganosiloxane V comprising, per molecule, at least two alkenyl radicals bonded to silicon atoms,
at least one catalyst E composed of at least one metal belonging to the platinum group,
at least one inhibitor D1 which is an acetylenic α,α′-diol, and
at least one organic acid or one inorganic acid D2, selected from the group consisting of orthophosphoric acid, orthophosphorous acid, periodic acid, sulfuric acid, sulfurous acid and thiosulfuric acid, and
b) the part B comprises:
at least one polyorganosiloxane H exhibiting, per molecule, at least two hydrogen atoms bonded to an identical or different silicon atom.

3. The composition X as claimed in claim 1, wherein the composition further comprises a third part C which comprises at least one additive F and which is separate from the parts A and B.

4. The composition X as claimed in claim 1, wherein the inhibitor D1 is an acetylenic α,α′-diol of following formula (1):
(R¹)(R²)(OH)C—C≡C—C(OH)(R³)(R⁴) (1)
in which the R¹, R², R³ and R⁴ radials, which are identical or different, represent independently of one another, a monovalent linear or branched alkyl group, a cycloalkyl group, a (cycloalkyl)alkyl group, an aromatic group or an arylalkyl group, and
the R¹, R², R³ and R⁴ radicals can be bonded in pairs so as to form a 5-, 6-, 7- or 8-membered aliphatic ring optionally substituted by one or more substituents.

5. The composition X as claimed in claim 1, wherein the inhibitor D1 is selected from the group consisting of the acetylenic α,α′-diols of following formulae (2) to (9):

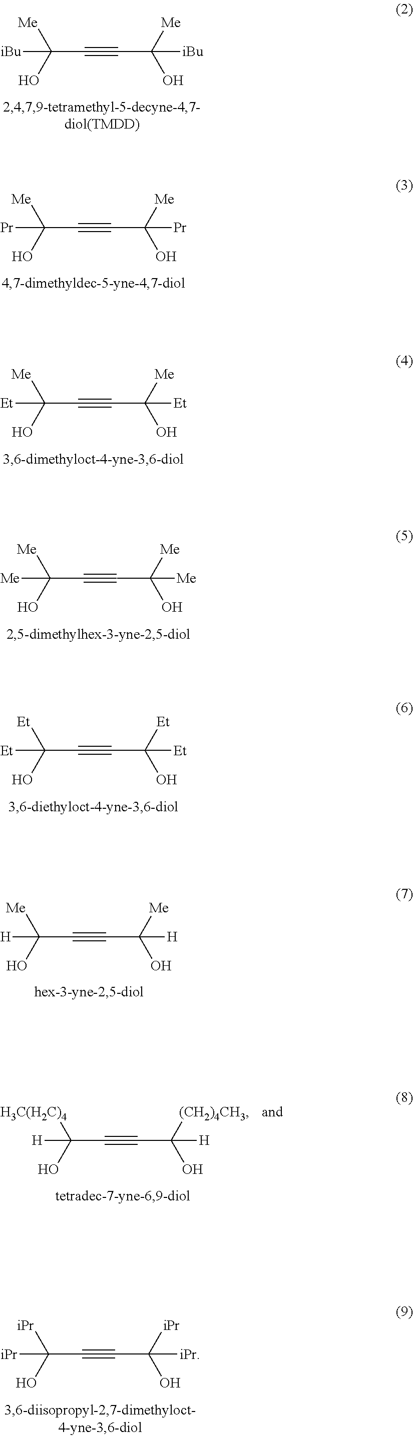

6. The composition X as claimed in claim 1, wherein the [inhibitor D1]/[acid D2] molar ratio is between 0.1 and 20.

7. The composition X as claimed in claim 1 wherein the acid D2 exhibits, in aqueous solution and at 25° C., at least one pKa having a value within the following range: −0.9≦pKa≦+6.5.

8. The composition X as claimed in claim 1, wherein the acid D2 is selected from the group consisting of: methanoic acid, orthophosphoric acid, heptanoic acid, trifluoroacetic acid and malonic acid.

9. The silicone composition X as claimed in claim 1, wherein the proportions of the polyorganosiloxane V and of the polyorganosiloxane H are such that the molar ratio of the hydrogen atoms bonded to the silicon in the polyorganosiloxane H to the alkenyl radicals bonded to the silicon in the polyorganosiloxane V is between 0.4 and 10.

10. The composition X as claimed in claim 1, wherein the composition X′ is obtained by mixing the parts of the composition X.

11. A silicone elastomer Y, obtained by crosslinking or curing e′-the silicone composition X′, as described according to claim 10.

12. A method of making a coating, the method comprising forming a coating using the composition X′ as described according to claim 10, and wherein the coating can be a base for a non-stick and water-repellent crosslinked elastomer coating on a solid support.

13. A solid support comprising a coating on at least a portion of a surface wherein the coating is comprised of the silicone composition X′ as described according to claim 9, and is crosslinked or cured by heating at a temperature of greater than 60° C.

14. A process for coating a flexible support S the process comprising the following stages a), b), c) and d):
a) preparing a silicone composition X as described in claim 1,
b) mixing the parts of the silicone composition X in order to form a composition X′,
c) depositing said silicone composition X′, continuously or noncontinuously, on said flexible support S, and
d) crosslinking the silicone composition X′ by heating at a temperature of greater than 60° C.

15. The process as claimed in claim 14, wherein the flexible support S is made of paper, of textile, of board, of metal or of plastic.

16. The process as claimed in claim 15, wherein the flexible support S is made of textile, of paper, of polyvinyl chloride (PVC), of polyester, of polypropylene, of polyamide, of polyethylene, of polyurethane, of nonwoven glass fiber fabrics or of polyethylene terephthalate (PET).

17. A silicone composition comprising:
at least one polyorganosiloxane V comprising, per molecule, at least two alkenyl radicals bonded to silicon atoms,
at least one catalyst C composed of at least one metal belonging to the platinum group,
at least one inhibitor D1 which is an acetylenic α,α′-diol, and
at least one organic acid or one inorganic acid D2, with the condition that the inorganic acid does not comprise platinum.

18. The composition X as claimed in claim 1, wherein in the at least one catalyst E, the at least one metal belonging to the platinum group is a Karstedt platinum.

19. The composition X as claimed in claim 1, wherein the the inorganic acid D2 does not comprise chloroplatinic acid.

20. The composition X as claimed in claim 2, wherein in the at least one catalyst E, the at least one metal belonging to the platinum group is a Karstedt platinum.

21. The composition X as claimed in claim 6, wherein the D1/D2 molar ratio is between 1 and 10.

22. The composition X as claimed in claim 6, wherein the D1/D2 molar ratio is between 2.5 and 6.5.

23. The method as claimed in claim 12, wherein the solid support is a flexible solid support selected from the group consisting of a paper, a board, a cellulose sheet, a metal sheet and a plastic film.

24. The solid support as claimed in claim 13, wherein the crosslinking or curing is conducted at a temperature between 70° C. and 200° C.

25. The solid support as claimed in claim 13, wherein the support is at least partially coated with a coating comprising the silicone elastomer Y as claimed in claim 11.

26. The process as claimed in claim 14, wherein the crosslinking is done by heating at a temperature between 70° C. and 200° C.

27. The silicone composition as claimed in claim 17, wherein the inorganic acid does not comprise chloroplatinic acid.
